(19) United States
(12) Patent Application Publication
(10) Pub. No.: US 2018/0056850 A1
(43) Pub. Date: Mar. 1, 2018

(54) LIGHTING SYSTEM, VEHICLE HEADLIGHT AND METHOD FOR CONTROLLING A LIGHTING SYSTEM

(71) Applicant: OSRAM GmbH, Munich (DE)

(72) Inventor: Stephan Schwaiger, Ulm (DE)

(21) Appl. No.: 15/688,887

(22) Filed: Aug. 29, 2017

(30) Foreign Application Priority Data
Aug. 31, 2016 (DE) 10 2016 216 364.7

(51) Int. Cl. B60Q 1/08; B60Q 1/14; F21S 8/10

(52) U.S. Cl. CPC B60Q 1/085; B60Q 1/143; F21S 48/1154; B60Q 2300/45; F21S 48/1747; B60Q 2300/122; B60Q 2300/334; F21S 48/1258

(57) ABSTRACT

A lighting system includes a first luminous component, with the emittable light of which a first illumination region is formable, and including a second luminous component, with the emittable light of which a second illumination region is formable. The first luminous component is configured in such a way that its light is dimmable and/or switchable on and off in a partial region of the first illumination region. The second luminous component is configured in such a way that its light is at least one of dimmable or switchable on and off in a partial region of the second illumination region, said partial region being formed such that it is at least larger than the minimum size, or the second luminous component is configured in such a way that its light is at least one of dimmable only in its entirety or is switchable on and off only in its entirety.

### CROSS-REFERENCE TO RELATED APPLICATION

This application claims priority to German Patent Application Serial No. 10 2016 216 364.7, which was filed Aug. 31, 2016, and is incorporated herein by reference in its entirety.

### TECHNICAL FIELD

Various embodiments relate generally to a lighting system for a vehicle headlight of a vehicle, wherein the lighting system includes a luminous component with which light is emittable. Furthermore, various embodiments relate generally to a vehicle headlight for a vehicle. Moreover, various embodiments relate to a method for controlling the lighting system.

### BACKGROUND

So-called matrix systems are known from the prior art. They have a multiplicity of light emitting diodes (LEDs), which are typically arranged in a column-like fashion but also indeed in a matrix-like fashion. A respective LED can be driven and thereby switched on and off and dimmed separately. An adaptive light can be created as a result. It would be conceivable, with such a matrix system, to mask out traffic signs by means of the adaptive light in order to prevent a driver of a vehicle in which the matrix system is arranged from being dazzled himself/herself. However, for this purpose it is necessary for the matrix system to have a high resolution, i.e. for example to switch off or to dim light in an angular range of less than 0.1° in an illumination region of the matrix system, in order to mask out a traffic sign. Furthermore, the matrix system would require a high radiation intensity of for example more than 40.5 kcd, in order to be used for example for a high beam (legal minimum is a radiation intensity of 40.5 kcd for a high beam pursuant to ECE R112). Moreover, it would be necessary that the matrix system can illuminate a large angular range, such as for example ±30° as viewed in the horizontal direction. Such a matrix system is not implementable at the present time from a technical standpoint, in particular with regard to the available structural space in a vehicle and/or with regard to costs. Usually only a resolution with an angular range of approximately 2.5° or greater is implementable with matrix systems used at the present time. In order to mask out a traffic sign, therefore, not only the traffic sign but a large region adjacent to the traffic sign is likewise masked out. Consequently, in the case of current matrix systems having coarse resolution, what is problematic is that if small “obstacles” are intended to be masked out, such as traffic signs, for example, a large region has to be masked out for this purpose, as a result of which this is also associated with a loss of a large region of range. Alternatively, it would be conceivable to accept the (own) dazzle of the driver, as a result of which, however, owing to the adaptation of the eye, a visibility is then restricted at least for a certain time.

### SUMMARY

A lighting system includes a first luminous component, with the emittable light of which a first illumination region is formable, and including a second luminous component, with the emittable light of which a second illumination region is formable. The first luminous component is configured in such a way that its light is dimmable and/or switchable on and off in a partial region of the first illumination region. The second luminous component is configured in such a way that its light is at least one of dimmable or switchable on and off in a partial region of the second illumination region, said partial region being formed such that it is at least larger than the minimum size, or the second luminous component is configured in such a way that its light is at least one of dimmable only in its entirety or is switchable on and off only in its entirety.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows, in a schematic illustration, a lighting system with a depicted radiation intensity distribution in a horizontal sectional view;

FIG. 2 shows, in a schematic illustration, a sum of radiation intensities of three luminous components of the lighting system from FIG. 1 in a horizontal sectional view;

FIG. 3 shows, in a schematic illustration, a smoothed radiation intensity distribution of the lighting system in a horizontal sectional view;

FIG. 4 shows, in a schematic illustration, the radiation intensity distribution from FIG. 3 with masking out of a partial region of the lighting system in a horizontal sectional view;

FIG. 5 shows, in a schematic illustration, the radiation intensity distribution from FIG. 3 with various possibilities for masking out in a horizontal sectional view.

### DESCRIPTION

The following detailed description refers to the accompanying drawings that show, by way of illustration, specific details and embodiments in which the invention may be practiced.

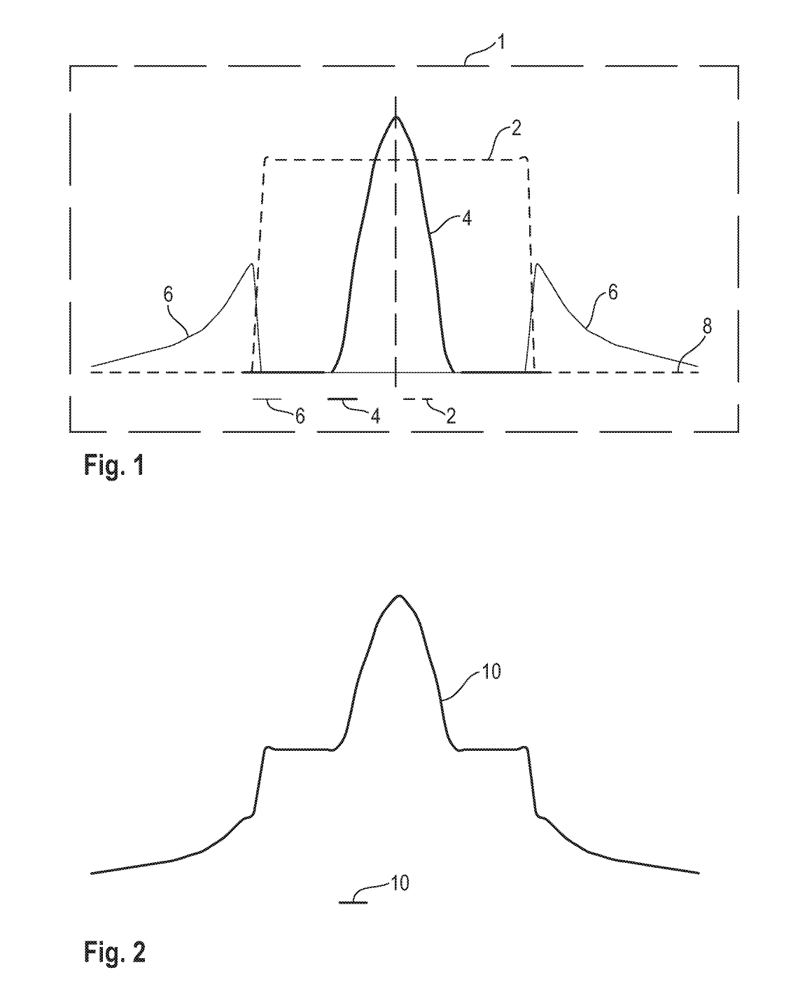

In accordance with FIG. 1, a lighting system 1 for a vehicle is illustrated schematically. Said lighting system can be used for a vehicle headlight, e.g. for a front headlight. In accordance with FIG. 1, an approximately horizontal sectional view through a light distribution is shown here. A first illumination region 2 of a first luminous component, a second illumination region 4 of a second luminous component and a third illumination region 6 of a third luminous component can be seen therein. The illumination regions 2 to 6 are illustrated here in each case by a radiation intensity plotted against an abscissa 8, which is a horizontal aperture angle of the lighting system 1. Consequently, in accordance with FIG. 1, a radiation intensity of a respective luminous component is plotted vertically and the aperture angle is plotted horizontally. The distribution of the radiation intensity against the aperture angle is applicable both to a position space directly in front of the headlight, and to an angle space or a luminous intensity distribution on an illuminated surface (e.g. roadway or road).

In accordance with FIG. 1, the luminous component 1 has a digital light processing system including a digital micromirror unit having a high resolution. Consequently, arbitrary partial regions can be masked out in the first illumination region 2, wherein a partial region has an extremely small size or minimum size. The second luminous component having the second illumination region 4 can have for example one light emitting diode (LED) or a plurality of LEDs and/or at least one light source formed as an LARP system, wherein a maximum radiation intensity in this embodiment is higher than in the case of the first luminous component in accordance with the first illumination region 2. The second luminous component is for example a so-called “boost”. Furthermore, the second luminous component can be dimmable and/or switchable on and off in its entirety. Furthermore, the second illumination region lies approximately centrally with respect to the first illumination region 2 and is significantly narrower than the latter. Consequently, in accordance with FIG. 1, the angular range of the second illumination region is significantly smaller than that of the first illumination region. The third illumination regions 6 of the third luminous component adjoin the first illumination region 2 laterally with respect thereto. These can likewise be dimmable and/or switchable on and off approximately in their entirety. The third illumination regions 6 or the lateral illumination thus have/has no contribution in the center of the light distribution.

A sum 10 of the illumination regions 2 to 6 or of the radiation intensities from FIG. 1 is illustrated in accordance with FIG. 2. A maximum possible radiation intensity at each angle can thus be seen.

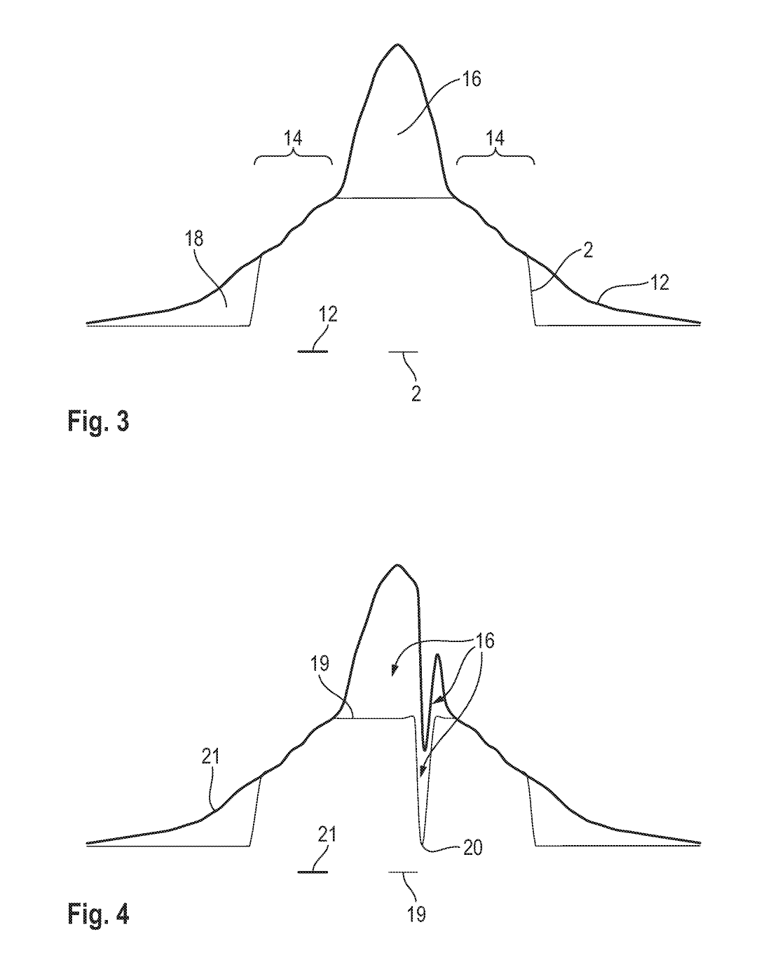

FIG. 3 shows a sum 12 of the radiation intensities of the luminous components, which sum has a softer profile in comparison with FIG. 2. For this purpose, in accordance with FIG. 3, in the first illumination region 2 partial regions are dimmed in its edge regions 14. In this case, the dimming is all the greater, the further away the illumination region is from the center. This dimming may be provided for a thermal design, since less radiation is emitted overall, and for a cornering light. In other words, in order to ensure a softer appearance and to utilize the lower thermal loading, light is dimmed at an edge of the illumination region. This light is increased again if the vehicle steers in this direction. In return, light is then reduced elsewhere (opposite edge). As a result, the entire thermal loading remains approximately constant and is lower than a theoretical (from an optical design) maximum loading.

In accordance with FIG. 3, the region 16 lying above the first illumination region 2 is the contribution of the second luminous component or of the “boost”. The contributions 18 of the third luminous component are illustrated laterally with respect to the second illumination region 4 in accordance with FIG. 3.

FIG. 4 illustrates the sum of the radiation intensities 21, wherein in the first illumination region 2, from FIG. 3, a partial region 20 is masked out or switched off, which leads to an illumination region 19. Said partial region 20 is for example a possible, in particular horizontal and vertical, position of a traffic sign. Since the second luminous component with the second illumination region or its contribution 16 to the total radiation intensity is still switched on, the radiation intensity is only reduced overall in the masked-out partial region 20 (see profile of the sum of the radiation intensities 21 at this location). Specifically, the first and second illumination regions are superimposed in said partial region 20. Consequently, a radiation intensity of the illumination of the traffic sign is significantly reduced, wherein overall a high range, in particular “alongside the traffic sign”, is still made possible.

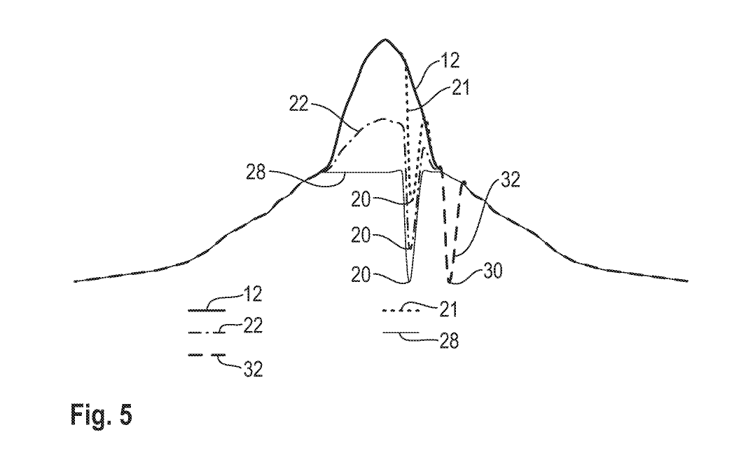

In accordance with FIG. 5, the sum of the radiation intensities 12 is illustrated. Furthermore, FIG. 5 shows a sum 22 of the radiation intensities where the partial region 20 of the first luminous component is masked out and where the second luminous component is dimmed in its entirety. Consequently, the radiation intensity in the partial region 20 is reduced here in comparison with FIG. 4.

This is evident in comparison with the sum—likewise depicted in FIG. 5—of the radiation intensities 21 for which, in a manner corresponding to FIG. 4, the partial region 20 of the first luminous component is switched off and the second luminous component is not dimmed.

In the case of the sum 28 of the radiation intensities in FIG. 5, the partial region 20 is masked out in the case of the first luminous component and the second luminous component is additionally switched off. As a result, radiation is no longer present in the partial region 20.

The masking out of the partial region in the case of the sums 22 and 28 can also be used to mask out other vehicles at a greater distance (sum 22) and at a smaller distance (sum 28). If a partial region 30 of the first luminous component which lies outside the second illumination region 4, see FIG. 1, is masked out, then no or only a reduced radiation is emitted in this partial region, independently of the second luminous component. A sum of the radiation intensities 32 is illustrated for this in accordance with FIG. 5. In principle, it is also possible for a plurality of objects, e.g. traffic signs, road signs or obstacles, to be masked out simultaneously, wherein this is effected for example as in the case of the partial region 20 and/or as in the case of the partial region 30. A lighting system for a vehicle including a first and second luminous component, which differ from one another, is disclosed. The first luminous component can mask out partial regions of its light field. By contrast, the second luminous component cannot mask out a partial region of its light field or can mask out only a partial region that is larger.

Since, on account of the forward movement and/or lateral movement and/or rotation of the vehicle, an angle and also a distance between the object to be masked out or to be illuminated with a reduced light power, e.g. a traffic sign or a road sign, change constantly, the light distributions described in the exemplary embodiments are also adapted constantly to the current situation. If a plurality of such objects are present, then it is possible, by means of evaluation software for camera images, to prioritize the objects, e.g. the traffic signs, according to their importance or relevance, such that the lighting system according to various embodiments is e.g. applied to the most highly prioritized object.

Various embodiments provide a lighting system for a vehicle headlight of a vehicle and a vehicle headlight which are configured cost-effectively and compactly and have a high resolution. Furthermore, various embodiments provide a method with such a lighting system with which safety is increased.

Various configurations are found in the dependent claims.

Various embodiments provide a lighting system for a vehicle, e.g. for a vehicle headlight of a vehicle. Said lighting system has at least one first luminous component, with the emittable light of which a first illumination region or a first light distribution is formable. Furthermore, at least one further, second luminous component is provided, which differs from the first luminous component. With its emittable light, a second illumination region or a second light distribution can be formable. In various embodiments, the luminous components are useable or operable jointly or together. In various embodiments, the first luminous component is configured in such a way that its light is dimmable and/or switchable on and off in at least one partial region of the first illumination region. In this case, the partial region has at least a minimum size. Furthermore, provision can be made for the second luminous component to be configured in such a way that its light is dimmable and/or switchable on and off in a partial region of the second illumination region, wherein the partial region is larger than the minimum size. Alternatively, it is conceivable for the second luminous component to be configured in such a way that its light is dimmable only in its entirety and/or is switchable on and off only in its entirety.

This solution may have the effect that required properties are divided among a plurality of luminous components. In this case, the first luminous component has a higher resolution than the second component, while for example the second component can ideally have a higher radiation intensity in comparison with the first luminous component. Consequently, the first luminous component can be designed for example for masking out smaller objects, such as a traffic sign, for example, while the second luminous component can be designed for example with regard to a high range or increases the range by superimposition with the first luminous component. Consequently, in various embodiments, the lighting system or the lighting contribution is divided into at least two different luminous components.

In other words, a high-resolution luminous component is used, which is designed with regard to a high resolution. In addition, it would be conceivable that the high-resolution luminous component can be restricted with regard to a radiation intensity and/or with regard to an illumination region (field of view (FOV)) in the vertical and horizontal directions. The second luminous component, which is useable as a so-called “boost”, can have a poorer resolution and/or be designed with regard to the range and/or have a smaller illumination region and/or be dimmed and/or switched on and off only with regard to its entire light distribution.

Consequently, the lighting system according to various embodiments is able to be assembled from cost-effective luminous components and has a high functionality which is not possible, or is possible only as a result of very high costs, in the conventional systems.

The vehicle can be an aircraft or a water-bound vehicle or a land-bound vehicle. The land-bound vehicle can be a motor vehicle or a rail vehicle or a bicycle. The use of the vehicle headlight in a truck or automobile or motorcycle may be provided.

In various embodiments, the second luminous component has a higher maximum radiation intensity than the first luminous component, as a result of which for example a range of the second luminous component can be greater in comparison with the first luminous component. Alternatively or additionally, it is conceivable for a high radiation intensity to be effected by the superimposition of the emission regions of the luminous components, as a result of which for example it would be conceivable for the radiation intensity of the second luminous component to be less than that of the first luminous component, since a high radiation intensity is present overall.

In various embodiments, an arbitrary partial region of the first illumination region of the first luminous component is dimmable and/or switchable on and off.

The partial region is for example an angular range from a total angular range of the first illumination region. Light emitted by the first luminous component can then be dimmable and/or switchable on and off in the angular range. If the second luminous component is likewise dimmable and/or switchable on and off in an angular range from a total angular range of the second illumination region, this angular range may be smaller than the angular range of the first luminous component.

The first luminous component can have a higher resolution. In various embodiments, the first luminous component has a high resolution. As a result, light is dimmable and/or switchable on and off for example in an angular range of less than or equal to 1°, e.g. less than or equal to 0.5°, e.g. less than or equal to 0.1°. The second luminous component may be configured such that it does not have a high resolution.

As already explained above, the first luminous component can be configured in such a way that therewith a partial region of the first illumination region of the size of a traffic sign, such as for example a traffic sign with regard to a speed limit or an overtaking prohibition, is dimmable and/or switchable on and off.

In various embodiments, a plurality or multiplicity of, e.g. arbitrary, partial regions, e.g. simultaneously, are dimmable and/or switchable on and off via the first luminous component in the first illumination region and/or via the second luminous component in the second illumination region. If the illumination regions overlap in sections, then e.g. the first luminous component and/or the second luminous component can dim and/or switch on and off at least one, e.g. arbitrary, partial region in the overlap region and at least one, e.g. arbitrary, partial region outside the overlap region, e.g. simultaneously.

In various embodiments, the first luminous component has a plurality of individual luminous pixels, at least some or all of which, e.g. independently of one another, are in each case dimmable and/or switchable on and off. Alternatively or additionally, provision can be made for the first luminous component to have an emission area, which is for example part of a conversion element of a laser activated remote phosphor system (LARP system). In this case, a light emitted from a partial area of the emission area can be dimmable and/or switchable on and off. That partial region or angular range of the first illumination region which is dimmable and/or switchable on and off is then determinable via the size of the partial area.

In a further configuration of the invention, the first luminous component may include a digital micromirror unit (DMD), which is irradiatable by at least one radiation source. A respective micromirror can form a luminous pixel. Consequently, the first luminous component can have a digital light processing (DLP) system in which a light beam is decomposed into pixels by the micromirror unit and is then reflectable pixel by pixel either into a projection path or out of the projection path. The illumination of such a DLP system can be effected either with conventional light sources, such as for example halogen lamps or discharge lamps (High Intensity Discharge (HID)), or with light emitting diodes (LEDs) or lasers (such as for example a laser activated remote phosphor (LARP) system). Alternatively or additionally, provision can be made for the first luminous component to include an LARP system, as already explained above. In this technology, a conversion element arranged at a distance from the radiation source, said conversion element including or essentially consisting of a phosphor, is irradiated with an excitation radiation, e.g. an excitation beam (pump beam, pump laser beam), e.g. with the excitation beam of one or a plurality of laser diodes. The excitation radiation of the excitation beam is at least partly absorbed by the phosphor and at least partly converted into a conversion radiation, the wavelengths and hence spectral properties and/or color of which are determined by the conversion properties of the phosphor. In the case of down-conversion, the excitation radiation of the radiation source is converted by the irradiated phosphor into conversion radiation having longer wavelengths than the excitation radiation. By way of example, with the aid of the conversion element, blue excitation radiation (blue laser light) can thus be converted into red or green or yellow conversion radiation (conversion light).

Alternatively or additionally, provision can be made for the first luminous component to have a single-row or multi-row matrix system including light sources arranged in a column- or matrix-like fashion, said light sources each forming a luminous pixel. The light sources may be in each case a light emitting diode (LED), which can be embodied such that they are of the same type, although it would also be conceivable to use different LEDs. A light emitting diode LED can be present in the form of at least one individually packaged LED or in the form of at least one LED chip including one or a plurality of light emitting diodes. A plurality of LED chips can be mounted on a common substrate (“submount”) and form an LED or be secured individually or jointly for example on a circuit board (e.g. FR4, metal-core circuit board, etc.) (“CoB”=Chip on Board). The at least one LED can be equipped with at least one dedicated and/or shared optical system for beam guiding, for example with at least one Fresnel lens or a collimator. Instead of or in addition to inorganic LEDs, for example on the basis of AlInGaN or InGaN or AlInGaP, generally organic LEDs (OLEDs, e.g. polymer OLEDs) are also usable. The LED chips can be directly emissive or include a phosphor disposed upstream. Alternatively, the LED can be a laser diode or a laser diode arrangement. It is also conceivable to provide one OLED luminous layer or a plurality of OLED luminous layers or an OLED luminous region. The emission wavelengths of the LED can be in the ultraviolet, visible or infrared spectral range. The LEDs can additionally be equipped with a dedicated converter. In various embodiments, the LED chips emit white light in the standardized ECE white field of the automotive industry, for example realized by a blue emitter and a yellow/green converter.

In various embodiments, the first luminous component is formed as a module. Furthermore, it is conceivable to provide a plurality or multiplicity of such modules. The modules here can be of the same type or of different types.

In various embodiments, the second luminous component has a module or a system having at least one light source having a high luminance, e.g. a higher luminance than the first luminous component. In this case, the light source can be configured for example as an LED or laser light source or as an LARP system or from a combination of these components. Structural space and costs can be saved by the modular configuration, which is simple in terms of device engineering. It is conceivable to provide a plurality or multiplicity of such modules. The modules here can be of the same type or of different types.

In various embodiments, a radiation intensity of the second luminous component or, during simultaneous operation of both luminous components, the common radiation intensity is at a maximum greater than or equal to 40.5 kcd, as a result of which said luminous component(s) is/are useable for example for a high beam function in a vehicle headlight.

It is conceivable for the second illumination region of the second luminous component, e.g. as viewed in the width direction, to be smaller than that of the first luminous component. As a result, the second luminous component can be designed e.g. for high ranges which are provided, for example, when the vehicle is driving straight on. Consequently, an e.g. horizontal illumination width of the second illumination region can be reduced. The width direction can lie for example in a horizontal plane in a direction transversely with respect to the radiation direction.

Alternatively, provision can be made for the illumination regions of the first and second luminous components to be equal. It would also be conceivable for the second illumination region to be larger than the first illumination region.

In a further configuration, the illumination regions of the first and second luminous components intersect or overlap. This may have the effect that in the intersection region, in the case of an intersection of the illumination regions, in the case of masking out a partial region in the first illumination region, radiation is nevertheless emitted by the second illumination region in said partial region if the second luminous component is switched on. By way of example, the second illumination region lies in the first illumination region as viewed with regard to a total angular range.

If the illumination regions are equal in size, then they can be congruent with one another.

In various embodiments, the illumination regions are provided in a far field of a vehicle headlight, since high light intensities are required in the far field, which leads to the problems with regard to dazzle of the vehicle driver or of oncoming traffic that are avoided by the lighting system according to various embodiments. Alternatively, it is conceivable for one or both illumination regions to be provided for an area in front or shorter ranges.

In various embodiments, the second illumination region extends approximately centrally in the first illumination region, e.g. as viewed approximately transversely with respect to the radiation direction in a horizontal plane or in the width direction. Alternatively or additionally, it is also conceivable to design the first illumination region asymmetrically, wherein a vehicle exterior or a lateral region in front of a vehicle is illuminated better. It is also conceivable for the second illumination region to extend excentrically relative to the first illumination region, for example if the first luminous component is used as low beam and additionally contributes to the high beam, that is to say assists the high beam.

In a further configuration, at least one third luminous component is provided. The latter may include one illumination region or a plurality of illumination regions. The third luminous component then makes it possible that for example the first illumination region of the first luminous component and/or the second illumination region of the second luminous component can be formed in a narrower fashion, that is to say in a manner reduced in size in the width direction, since this can be compensated for by the illumination region of the third luminous component. As a result of the smaller illumination region of the first luminous component and/or second luminous component, the latter can be configured more cost-effectively. Consequently, with the at least one illumination region of the third luminous component, the first and/or second illumination region of the first and/or second luminous component can be widened or increased in size, e.g. in the width direction.

It is conceivable for the third luminous component to be formed as a module. Furthermore, it is conceivable to provide a plurality or multiplicity of such modules. The modules here can be of the same type or of different types.

The third luminous component can be a radiation source which for example is embodied more simply than the first luminous component in terms of device engineering and for example is switchable on and off and/or dimmable only in its entirety and/or has a very low resolution in comparison with the first luminous component. As a result, the first and/or second luminous component or the total illumination thereof can be extended. Alternatively, it is conceivable for the third luminous component to have a low resolution in comparison with the first luminous component, in order to extend the first and/or second luminous component. Alternatively, it is conceivable for the third luminous component to have an approximately corresponding resolution in comparison with the first luminous component, that is to say that a controllable partial region or partial angular range has an approximately corresponding minimum size. As a result, the first luminous component can be extended with regard to its complete functionality.

In various embodiments, the at least one illumination region of the at least one third luminous component adjoins the first illumination region of the first luminous component or is alternatively adjacent thereto. In various embodiments, the at least one illumination region of the third luminous component has no contribution in the central or center region. It is also conceivable for a third illumination region to be provided, as viewed in the width direction, on both sides of the first illumination region.

In various embodiments, a radiation intensity of the third luminous component is less than that of the first luminous component, as a result of which the third luminous component can be formed cost-effectively.

In various embodiments, an outer region of the first illumination region of the first luminous component, as viewed in the width direction, is dimmed in comparison with the rest of the first illumination region. This is effected for example by the dimming of the outer luminous pixels of the first luminous component. Such dimming is advantageous for a thermal design. Moreover, a so-called “bending” or cornering light can be made possible as a result, in which, during cornering, the light intensity is reduced by dimming in the central region and is increased in the direction of the curvature of the bend. It would also be conceivable to dim the second illumination region of the second luminous component in the outer region (possibly also in addition), e.g. as viewed in the width direction, in order then to provide a “bending” for example.

In various embodiments, the first luminous component is configured in such a way that in a first operating state light is emitted in the entire first illumination region or, e.g. in an angle-dependent manner, in one or a plurality of partial regions of the first illumination region with a first radiation intensity, which is below its maximum radiation intensity and is for example 80% of the maximum radiation intensity. In the first operating state, the first radiation intensity can then be the maximum possible radiation intensity in the first illumination region, wherein light can then be dimmed further with regard to its radiation intensity in at least one partial region of the first illumination region. In other words, the light can be dimmed in an angle-dependent manner in conjunction with reduced maximum radiation intensity, wherein then the exemplary 80% of the absolute maximum radiation intensity can thus be only a (relative) maximum of the currently set light distribution. In a second operating state, the first luminous component can emit light with a second radiation intensity, which is e.g. above the first radiation intensity and has for example the maximum radiation intensity. This solution has the advantage that the second operating state can be used for example when the second luminous component is dimmed or switched off. In other words, the first luminous component can be driven with, for example, a maximum of 80% radiation intensity for example in principle only in the first operating state, such that an in particular complete or partial “boosting” to a maximum radiation intensity (second operating state) is made possible when the second luminous component is dimmed or switched off or it is desired for other reasons. Consequently, the first operating state is e.g. used when the second luminous component is not dimmed or switched off. Furthermore, the second operating state is e.g. used when the second luminous component is switched off or dimmed. In a further configuration, at least one further operating state (intermediate stage) can be provided between the first and second operating states.

In various embodiments, the lighting system has a camera system and image processing electronics in order to detect in particular objects such as, for example, traffic signs or road signs, oncoming traffic, etc. and then to mask them out by means of the first luminous component.

Various embodiments provide a vehicle headlight including a lighting system in accordance with one or more of the preceding aspects. In this case, a radiation axis of the lighting system e.g. extends in the longitudinal direction of the vehicle. The vehicle headlight can furthermore be a front headlight, for example.

In various embodiments, the second luminous component is switched on if no oncoming traffic is present. It would be conceivable to switch on the second luminous component despite oncoming traffic if the latter is at a great distance from the lighting system and/or if the oncoming traffic is situated outside the illumination region of the second luminous component.

It is conceivable for the first and/or the second luminous component to be composed of a plurality of sub-components. In this case, it is furthermore conceivable for said sub-components not to be physically and/or mechanically connected to one another.

It is conceivable for other road users additionally to be masked out alongside the masking out of objects, such as traffic signs, for example, with the lighting system according to various embodiments by virtue of the second luminous component and/or the first luminous component (or parts thereof) being dimmed, for example.

In various embodiments, in the lighting system, the range is maintained up to a very small angular distance to the object masked out, such as the traffic sign, the oncoming traffic, for example.

In a method according to various embodiments for controlling a lighting system in accordance with one or more of the preceding aspects, it is provided that the light of the first luminous component is dimmed or switched off in a partial region of the first illumination region, said partial region having at least a minimum size, in order to avoid (own) dazzle, for example on account of a traffic sign. In various embodiments, provision can be made for the first and second luminous components to be switched on jointly at least at times. This can lead to a high range and a wide illumination, with objects being prevented from being dazzled.

In various embodiments, in the method, upon the dimming and/or switching off of the light of the first luminous component, the second luminous component remains switched on and/or remains at least partly switched on and/or is dimmed and/or is at least partly dimmed.

### LIST OF REFERENCE SIGNS

Lighting system 1

First illumination region 2

Second illumination region 4

Third illumination region 6

Abscissa 8

Sum of the radiation intensities 10

Sum of the radiation intensities 12

Edge region 14

Region 16

Contribution of third luminous component 18

Partial region 20

Sum of the radiation intensities 21

Sum of the radiation intensities 22

Sum of the radiation intensities 26

Sum of the radiation intensities 28

Partial region 30

Sum of the radiation intensities 32

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting system for a vehicle, comprising:
a first luminous component, with the emittable light of which a first illumination region is formable, and comprising
a second luminous component different therefrom, with the emittable light of which a second illumination region is formable,
wherein the luminous components are useable jointly, and
wherein the first luminous component is configured in such a way that its light is at least one of dimmable or switchable on and off in a partial region of the first illumination region, said partial region having at least a minimum size, and
wherein the second luminous component is configured in such a way that its light is at least one of dimmable or switchable on and off in a partial region of the second illumination region, said partial region being formed such that it is at least larger than the minimum size, or
wherein the second luminous component is configured in such a way that its light is at least one of dimmable only in its entirety or is switchable on and off only in its entirety.

2. The lighting system of claim 1,
wherein the first luminous component is configured in such a way that therewith at least one of a partial region of the first illumination region of the size of a traffic sign or road sign is at least one of dimmable or switchable on and off.

3. The lighting system of claim 1,
wherein the first luminous component has a plurality of individual luminous pixels, at least some or all of which are in each case at least one of dimmable or switchable on and off, or
wherein the first luminous component has an emission area, wherein a light emitted from a partial area of the emission area is dimmable and/or switchable on and off, or
wherein the first luminous component has a digital micromirror unit, which is irradiatable by at least one radiation source, wherein a respective micromirror forms a luminous pixel, or
wherein the first luminous component has a single-row or multi-row matrix system comprising radiation sources arranged in a column- or matrix-like fashion, said radiation sources each forming a luminous pixel.

4. The lighting system of claim 1,
wherein the second luminous component comprises a module having at least one radiation source having a high luminance.

5. The lighting system of claim 1,
wherein at least one of the first luminous component or the second luminous component comprises a laser activated remote phosphor system (LARP system).

6. The lighting system of claim 1,
wherein the second illumination region of the second luminous component is smaller than the first illumination region of the first luminous component.

7. The lighting system of claim 1,
wherein the illumination regions of the first and second luminous components overlap.

8. The lighting system of claim 1,
wherein at least one third luminous component is provided, the at least third illumination region of which extends the first or the second illumination region of the first or second luminous component.

9. The lighting system of claim 1,
wherein the first illumination region is dimmed in its outer region as viewed approximately transversely with respect to the radiation direction and approximately in a horizontal plane.

10. The lighting system of claim 1,
wherein the first luminous component in a first operating state emits light in the first illumination region with a first radiation intensity, which is below its maximum radiation intensity, and wherein the first luminous component in a second operating state emits light at least in a partial region of the first illumination region in a second radiation intensity, which is above the first radiation intensity.

11. The lighting system of claim 1,
wherein a plurality or multiplicity of partial regions are at least one of dimmable or switchable on and off at least one of via the first luminous component in the first illumination region or via the second luminous component in the second illumination region.

12. A vehicle headlight, comprising:
a lighting system, comprising:
a first luminous component, with the emittable light of which a first illumination region is formable, and comprising
a second luminous component different therefrom, with the emittable light of which a second illumination region is formable,
wherein the luminous components are useable jointly, and
wherein the first luminous component is configured in such a way that its light is dimmable and/or switchable on and off in a partial region of the first illumination region, said partial region having at least a minimum size, and
wherein the second luminous component is configured in such a way that its light is at least one of dimmable or switchable on and off in a partial region of the second illumination region, said partial region being formed such that it is at least larger than the minimum size, or
wherein the second luminous component is configured in such a way that its light is at least one of dimmable only in its entirety or is switchable on and off only in its entirety.

13. A method for controlling a lighting system,
the lighting system comprising:
a first luminous component, with the emittable light of which a first illumination region is formable, and comprising
a second luminous component different therefrom, with the emittable light of which a second illumination region is formable,
wherein the luminous components are useable jointly, and
wherein the first luminous component is configured in such a way that its light is dimmable and/or switchable on and off in a partial region of the first illumination region, said partial region having at least a minimum size, and
wherein the second luminous component is configured in such a way that its light is at least one of dimmable or switchable on and off in a partial region of the second illumination region, said partial region being formed such that it is at least larger than the minimum size, or
wherein the second luminous component is configured in such a way that its light is at least one of dimmable only in its entirety or is switchable on and off only in its entirety;
the method comprising:
at least one of dimming or switching off the light of the first luminous component in a partial region of the first illumination region, said partial region having at least a minimum size, in order to avoid or to reduce dazzle.

14. The method of claim 13,
wherein upon the at least one of dimming or switching off of the light of the first luminous component, the second luminous component remains switched on or remains at least partly switched on or is dimmed or is at least partly dimmed or switched off.
